(19) United States
(12) Patent Application Publication
(10) Pub. No.: US 2002/0017058 A1
(43) Pub. Date: Feb. 14, 2002

(54) Lower feed type flowerpot having ventilation maintaining function

(76) Inventor: Hwa Suk Chung, Kyong Kido (KR)

Correspondence Address: Yisun Song, Esq., Hunton & Williams, Suite 1200, 1900 K Street, N.W., Washington, DC, 20006, US

(21) Appl. No.: 09/918,567

(22) Filed: Aug. 1, 2001

(30) Foreign Application Priority Data
Aug. 1, 2000 (KR) 20-0207920

(51) Int. Cl. A01G 25/00

(52) U.S. Cl. 47/79

(57) ABSTRACT

The present invention relates to a flowerpot, more particularly, to lower feed type flowerpot that receives a minimal amount of soil for supporting an upper part of plant, while supplying appropriate water and air to the soil to provide a favorable atmosphere for plant growth. A flowerpot of the present invention may be separated into an upper clay room (20) and a lower water room (30) by a partition wall (10). A center portion of the partition wall (10) includes a water absorbing portion (14) extending downward to the water room (30) while communicating with the clay room (20). An upper part of the water room (30) may have at least one hole (31) for feeding, draining and providing ventilation so that an air inflow room may be formed between the clay room and the water room having a height substantially equal to an opening level of the hole and an upper side of the water room.

### CROSS REFERENCE TO RELATED APPLICATION

This application claims priority from Korean patent application no. 20-0207920, filed Aug. 1, 2000, which is hereby incorporated by reference.

### FIELD OF THE INVENTION

The present invention relates to a flowerpot, more particularly, to a lower feed type flowerpot for receiving a minimal amount of soil (or clay) for supporting an upper part of a plant, where an appropriate amount of water and air are received by the soil thereby providing a favorable atmosphere for plant growth, and further maintaining ventilation where water levels may be visually checked, and where the plant may be watered through a water storing function even when water is not fed for predetermined amount of time.

### BACKGROUND OF THE INVENTION

Generally, a flowerpot is provided for plant culture where soil (or clay) is filled inside the flowerpot for maintaining an upper portion of the plant as well as supplying water and plant nutrients. A penetrating hole formed on the bottom surface of the flowerpot provides air circulation and water drainage. A plurality of punched holes are generally formed at a peripheral side of a lower part of a flowerpot.

By the above construction, water supplied to the soil is not properly absorbed but drained through to the bottom of the flowerpot. When a flowerpot is kept indoors, contamination at the bottom surface may be reduced by drained soil and water through the penetrating hole. However, the traditional flowerpot depends on the moisturizing ability of soil for providing water and nutrients. The soil or clay amount and flowerpot size may be determined by growth characteristics of the plant. Therefore, in the case of the plant having a high water absorbing ability, a larger flowerpot than needed is oftentimes used. Thus, it may be difficult to maintain appropriate water levels and maneuver an oversized and heavy flowerpot.

Traditional flowerpots have penetrating holes to allow water to be drained where residual water may collect at the bottom of the flowerpot. As a result, the penetrating hole may be soaked by the drained water and further blocked. Thus, fresh air may be prevented from flowing throughout the inside of the flowerpot, resulting in ventilation problems associated with the plant root. Further, plant root decay may eventually occur. To solve these problems, a user may be required to move the flowerpot where water can flow. After the water has been drained through the penetrating hole of the flowerpot, the user can then re-position the flowerpot. However, a clay flowerpot full of water is oftentimes heavy and may be difficult to transport, and significantly difficult for women or children.

A user may be required to check on the water rate and periodically feed the plant with water. In some instances, it is difficult for the user to visually check on the water level. Furthermore, the amount of water may depend on various growth conditions in accordance with the type of plant. As a result, a user oftentimes confronts difficulties in determining an appropriate amount and frequency of water needed.

Especially, in the case of an outdoor flowerpot, water is often needed at least more than once a day. Depending on weather conditions, plants may quickly dry out and die if not maintained diligently.

These and other drawbacks exist with current flowerpot structures.

### SUMMARY OF THE INVENTION

Accordingly, the present invention addresses the above mentioned problems. An advantage of the present invention includes providing a flowerpot that receives a minimum amount of water for supporting a plant root on an upper part of a flowerpot, supplying an appropriate amount of water and nutrients to the soil and maintaining the water at a reasonable moisturizing rate, thereby providing a flowerpot capable of optimizing plant growth.

Other purposes of the present invention may include providing a flowerpot with an air inflow room formed between a clay room and a water room wherein the clay room and the water room are connected, and where appropriate water and fresh air are supplied to maintain a favorable or optimum condition for the plant growth. Further, the present invention provides a water storage function, so that the plant may not dry out and die even if water can not be supplied during a predetermined period.

Other purposes of the present invention may include a flowerpot with a feature that enables a user to visually check an internal water level from the exterior of the flowerpot.

The present invention to obtain the above described purposes, is characterized in that the flowerpot is separated into an upper clay room and a lower water room by a partition wall. A center portion of the partition wall is provided with a water absorbing portion extending downward to the water room while communicating with the clay room, and an upper part of the water room having at least one hole for feeding, draining and providing ventilation. An air inflow room is formed between the clay room and the water room, having a height substantially equal to an opening level of a penetrating hole and an upper surface of the water room.

The clay room and the water room of the present invention may be constructed of a separate structure such that the clay room is stack on an upper side of the water room, and the partition wall includes the water absorbing portion supported over a supporting portion provided on a lower part of the clay room.

Also, the present invention is characterized in that a penetrating hole has a protruding body external to the peripheral side of the flowerpot.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a perspective view showing a general construction of a flowerpot, in accordance to an embodiment of the present invention.

FIG. 2 is a cross sectional view showing a flowerpot, in accordance to an embodiment of the present invention.

FIG. 3 is a cross sectional view showing another embodiment of the present invention.

### DETAILED DESCRIPTION OF THE PREFERRED EMBODIMENTS

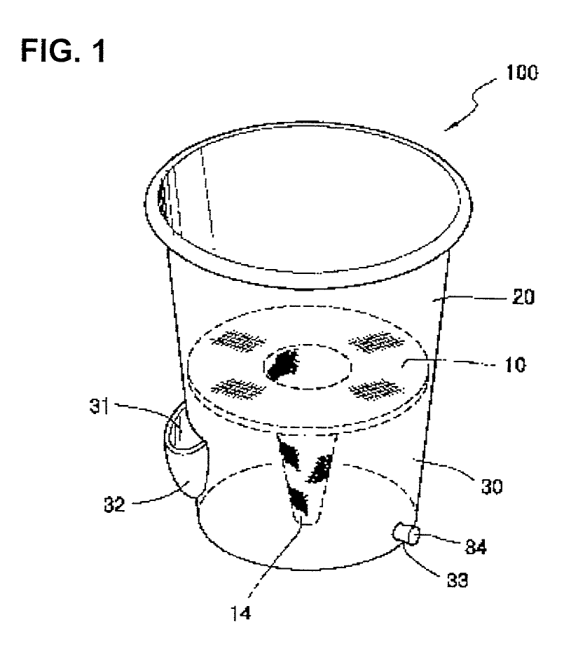

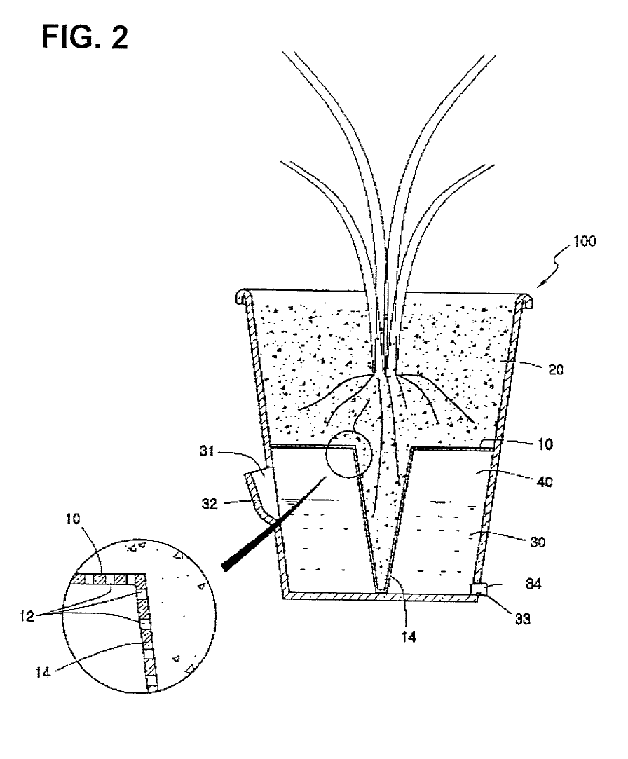

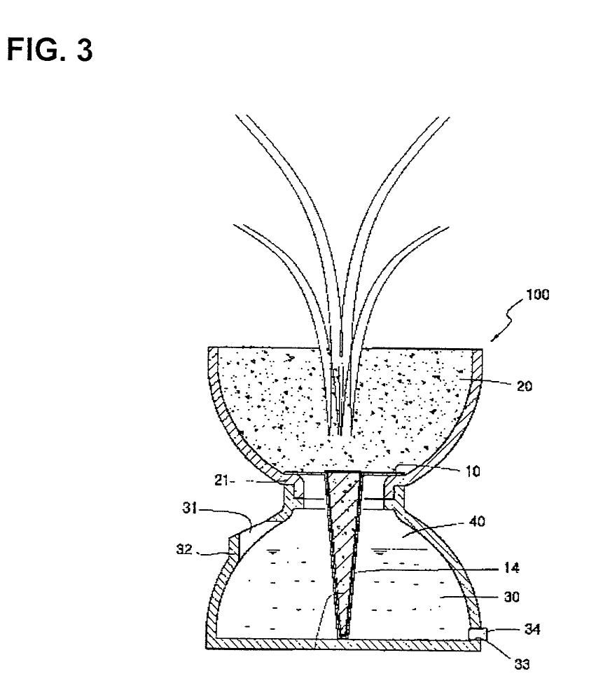

FIG. 1 is a perspective view showing a general construction of a flowerpot, in accordance to an embodiment of the present invention. FIG. 2 is a cross sectional view a flowerpot, in accordance to an embodiment of the present invention. FIG. 3 is a cross sectional view showing another embodiment of the present invention.

As shown, the flowerpot (100) of the present invention includes a partition wall (10) constructed of a porous net type material, an upper clay room (20) and a lower water room (30) forming an inner space.

Upper clay room (20) is separated by partition wall (10) which provides the use of a minimal amount of soil for supporting plant roots. The present invention may be constructed such that water needed for plant growth is received separately in water room (30) at a lower side of the flowerpot, so that the flowerpot volume may be minimized. Therefore, manufacturing and overall weight of the flowerpot may be reduced. Further, transportation of the flowerpot may be facilitated due to a smaller size and lighter weight.

The flowerpot (100) of the present invention, as shown in FIG. 2, may be formed as a single body with clay room (20) and water room (30). FIG. 3 shows a flowerpot formed of a separated clay room (20) and water room (30).

Partition wall (10) positioned between clay room (20) and water room (30) may be constructed of a net type material having a plurality of fine porous apertures (12). A center portion of the partition wall (10) may be provided with water absorbing portion (14) which extends downward toward the water room (30) while maintaining a predetermined width. Water absorbing portion (14) causes water (or moisture) to be supplied to the upper clay room (20) where water is absorbed from the water room (30), thereby allowing the clay room (20) to maintain an appropriate amount of water or moisture.

Water absorbing portion (14) may be formed so as to communicate with the clay room (20), an inner side of the water absorbing portion (14) may also be filled with clay or soil. Water absorbing portion (14) may be formed of net type structure having fine apertures.

Water absorbed from the water room (30) may be supplied to the upper clay room (20) by the water absorbing portion (14), which may include a sponge, a fiber material or other absorbing material.

As shown in FIG. 3, the water absorbing portion (14) may extend downward from a center portion of the partition wall (10). Absorbing materials, such as a sponge or other material having absorption qualities may be used. The upper side of the water absorbing portion (14) may meet with soil of upper clay room (20), thereby enabling the clay room (20) to be supplied with an appropriate amount of water or moisture.

FIG. 3 shows an embodiment of the present invention having a clay room (20) and a water room (30) separated from each other. Other shapes and designs may be implemented in accordance with the present invention, as varying needs of manufacturers or other entities may be accommodated. Supporting portion (21) may protrude around a lower portion of the lower clay room (20). The partition wall (10) may also be supported over the supporting portion (21).

An upper side of the water room (30) proximate to the partition wall (10) may have at least one penetrating hole (31). Water (or other elements) may be supplied to the inside of the water room (30) through the penetrating hole (31). For example, when a sufficient amount of water has made the clay room (20) wet enough due to rain over a period of time, an excess amount of water may safely overflow through the penetrating hole (31).

In other words, the penetrating hole (31) may enable a user to provide water to a plant as well as provide an water overflow function. Air inflow room (40) having a height substantially equal to an opening level of the penetrating hole (31) and an upper surface of water room (30) may be maintained between the clay room (20) and the water room (30).

Fresh air may flow into an air inflow room (40) through the penetrating hole (31) so that air may circulate throughout the air inflow room (40) and may be supplied to the clay room (20) via the net type partition wall (10). Therefore, the clay room (20) may be supplied with fresh air, thereby improving plant growth and smooth air respiration of the plant root.

Therefore, it is possible to maintain water for more than a number of days, such as 10 days, without having to supply additional water, when enough water is filled in the water room (30), even during in hot and dry summer period. For example, a water and fertilizer mixture may be supplied to the clay room (20). Thus, the plant may be safely cultured where manufacturing and other costs may be reduced.

At a peripheral of the penetrating hole (31), a protruding body (32) may be tilted to form an external opening to the water room (30), so that water may be easily supplied to the water room (30) via the protruding body (32). When water is supplied into the water room (30), the water is filled inside of the protruding body (32), so that an appropriate inflow amount can be easily adjusted.

A residual amount of water supplied to the water room (30) through the penetrating hole (31) may be observed. In particular, by forming the protruding body (32) at the peripheral side of the penetrating hole (31), water levels may be observed. Users may observe the inside of the penetrating hole (31) through the protruding body (32) and acknowledge a residual amount of supplied water contained in the water room (30). Users may supply additional water as needed into the water room at an appropriate time. Thus, water levels may be protected even if water supply is stopped due to the water (or moisture) that flows to the soil of the clay room (20).

In addition, as described above, when the water room (30) is formed of a transparent material, moss can be formed at the side wall of the water room (30) due to excessive amount of sunlight transmitted to the inside of the water room (30). Accordingly, it is preferable to form the water room (30) with opaque materials of various colors, where residual amounts of water can be checked in water room (30) through penetrating hole (31) having a protruding body (32). In addition, the water room may be formed of a glossy material of various colors.

At the lower part of the above constructed water room (30), a water drain hole (33) is provided. This drain hole (33) is used for draining water contained in the water room (30) and is enclosed by an enclosing cap (34). In the case when water in the water room (30) is old and contaminated or when water needs to be changed due to other reasons, the drain hole (33) may provide a draining function for water in water room (30) by removing the enclosing cap (34) from the water drain hole (33).

By this construction of the present invention, water supplied to the water room (30) of the flowerpot may be absorbed by soil filled in the water absorbing portion (14). The absorbed water may be supplied to the soil in clay room (20). Therefore, soil in the clay room (20) may absorb an appropriate amount of water through the water absorbing portion (14) in accordance with an amount of the absorbed waters.

Also, fresh air may be supplied to the clay of the clay room (20) through the air inflow room (40) provided between the clay room (20) and the water room (30), so that an appropriate amount of water, oxygen, and other nutrients useful for plant growth may be continuously supplied, thereby facilitating plant growth at a favorable or optimal atmosphere.

As can be seen from the above described embodiments, in accordance with the lower feed type flowerpot having a ventilation maintaining function of the present invention, an upper part of clay room (20) may be separated by a partition wall (10) wherein a minimal amount of soil is used for supporting plant roots. Manufacturing and other costs may be significantly reduced. Water for plant growth may be received in a separate or connected water room (30) of the flowerpot, thereby minimizing flowerpot volume and facilitating transport due to a reduction in overall weight.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

1. A lower part feed type flowerpot having a ventilation function comprising:
an upper clay room for supporting soil for a plant; and
a lower water room below the upper clay room for holding water for the plant;
wherein the upper clay room and the lower water room are separated by a net type partition wall having a center portion wherein the center portion of the partition wall comprises a net type water absorbing portion extending downward to the water room while communicating with the clay room,
wherein an upper portion of the water room comprises at least one penetration hole for at least one of feeding water, draining and providing ventilation, thereby providing an air inflow room between the clay room and the water room having a height substantially equal to an opening level of the penetrating hole and an upper surface of the water room.

2. The lower part feed type flowerpot of claim 1, wherein the clay room and the water room are constructed of separate structures such that the clay room is stacked on an upper side of the water room, and wherein the partition wall comprises a water absorbing portion located over a supporting portion of a lower part of the clay room.

3. The lower part feed type flowerpot of claim 1 wherein the penetrating hole comprises a protrusion body formed on an outside surface of the flowerpot.
